(19) United States
(12) Patent Application Publication
(10) Pub. No.: US 2026/0332652 A1
(43) Pub. Date: Oct. 22, 2026

(54) INTERNET PROTOCOL MULTIMEDIA SUBSYSTEM, IMS, NODES, CORE NETWORK NODES, AND METHODS FOR SELECTING A SERVING IMS NODE INSTANCE IN A COMMUNICATIONS NETWORK

(71) Applicant: Telefonaktiebolaget LM Ericsson (publ), Stockholm (SE)

(72) Inventor: George FOTI, Dollard des Ormeaux (CA)

(21) Appl. No.: 19/104,592

(22) PCT Filed: Aug. 8, 2023
(86) PCT No.: PCT/EP2023/071895

§ 371 Date: Feb. 18, 2025

Related U.S. Application Data
(60) Provisional application No. 63/371,761, filed on Aug. 18, 2022.

(51) Int. Cl. H04L 65/1016; H04L 65/1073; H04W 48/18

(52) U.S. Cl. CPC H04L 65/1016; H04L 65/1073; H04W 48/18

(57) ABSTRACT

A method performed by a first Core Network (CN) node. The method is for assisting in selecting a serving Internet protocol Multimedia Subsystem, IMS, node instance to serve a User Equipment, UE, in a communications network. The first CN node sends (201) a first subscription request to a second CN node. The first subscription request requests to be informed about serving IMS node instances registered in the second CN node. The serving IMS node instances are operating in an IMS network in the communications network. The first CN node receives (202) a list from the second CN node according to the subscription request. The list is a list of serving IMS node instances and their respective profiles. When the UE registers in the IMS network, the first CN node sends (204) to a second IMS node, the list of serving IMS node instances and their respective profiles. This to assist the second IMS node in selecting

### TECHNICAL FIELD

Embodiments herein relate to a first Core Network (CN) node, a second CN node, a first serving Internet protocol Multimedia Subsystem (IMS) node, and a proxy IMS node and methods therein. In some aspects, they relate to assisting in selecting a serving IMS node instance.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g., eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, the 5G aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of Machine to Machine (M2M) communication, also known as the Internet of things, aiming at lower cost, lower battery consumption and lower latency than 4G equipment.

IMS is a well-known 3GPP standard allowing sessions to be setup between two or more parties for a broad variety of services such as voice or video call, interactive messaging sessions or third-party specific applications.

3GPP Technical specification (TS) 23.501 and TS 23.502 define an architecture and procedures for exposure of capabilities of the 5G Core network (5GC).

This includes a Network Exposure Function (NEF) as a function within the 5GC in charge of securely expose network Function (NF) capabilities and events to Application Functions (AF)s external to the 5GC.

A Home Subscriber Server (HSS) may be configured with one or more Serving CSCFs (S-CSCFs) and the services they support. When a UE registers with an IP Multimedia Subsystem (IMS), the HSS sends a list of configured S-CSCFs and the services they support to an Interrogating Call Session Control Function (I-CSCF). The I-CSCF selects an S-CSCF that can fulfil what the UE needs, which is stored in a UE record in the HSS as long as the UE stays registered with the IMS.

### SUMMARY

As part of developing embodiments herein, the inventor identified a problem that will first be described.

There is a push to get away from the above-mentioned approach and instead support S-CSCF discovery in IMS, e.g., similar to as in 5G, as opposed to configuring anything in HSS. Information needs to be configured through O&M procedures in HSS and failures cannot be detected except in real time.

However, there is no standardized solution in IMS to overcome these problems.

An object of embodiments herein is to improve the performance of a communications network.

According to an aspect, the object is achieved by a method performed by a first Core Network, CN, node. The method is for assisting in selecting a serving Internet protocol Multimedia Subsystem, IMS, node instance to serve a User Equipment, UE, in a communications network. The first CN node sends a first subscription request to a second CN node. The first subscription request requests to be informed about serving IMS node instances registered in the second CN node. The serving IMS node instances are operating in an IMS network in the communications network. The first CN node receives a list from the second CN node according to the subscription request. The list is a list of serving IMS node instances and their respective profiles. When the UE registers in the IMS network, the first CN node sends to a second IMS node, the list of serving IMS node instances and their respective profiles. Th is to assist the second IMS node in selecting a specific serving IMS node instance to serve the UE based on the list of serving IMS node instances and their respective profiles.

According to another aspect, the object is achieved by a method performed by a second Core Network, CN, node. The method is for assisting in selecting a serving Internet protocol Multimedia Subsystem, IMS, node instance to serve a User Equipment, UE, in a communications network. The second CN node receives a registration of a number of serving IMS node instances and their respective profile. The second CN node receives a first subscription request from a first CN node. The first subscription request requests to be informed about serving IMS node instances registered in the second CN node. The second CN node sends a list to the first CN node. The list is a list of the registered serving IMS node instances and their respective profiles, according to the subscription request. This enables the first CN node to assist a second IMS node in selecting a specific serving IMS node instance to serve the UE registered in the IMS network, based on the list of serving IMS node instances and their respective profiles.

According to another aspect, the object is achieved by a method performed by a first serving Internet protocol Multimedia Subsystem, IMS, node instance. The method is for assisting in selecting a specific serving Internet protocol Multimedia Subsystem, IMS, node instance to serve a User Equipment, UE, in a communications network.

The first serving IMS node instance sends to a second CN node a registration of the specific serving IMS node instance and its profile.

The second CN node will inform a subscribing first CN node about the specific serving IMS node instance and its profile registered in the second CN node. This enables the first CN node to assist a second IMS node in selecting a specific serving IMS node instance to serve the UE registered in the IMS network, based on a list of serving IMS node instances and their respective profiles comprising the specific serving IMS node instance and its profile.

According to another aspect, the object is achieved by a method performed by a proxy Internet protocol Multimedia Subsystem, IMS node. The method is for assisting in selecting a serving IMS node instance to serve a User Equipment, UE, in a communications network. The proxy IMS node is using a new serving IMS node instance.

When using a new selected specific serving IMS node instance the proxy Internet protocol Multimedia Subsystem, IMS node sends to a third Core Network, CN, node, a third subscription request to subscribe to be notified when the specific serving IMS node instance fails.

The proxy Internet protocol Multimedia Subsystem, IMS node receives a notification from the third CN node. The notification notifies that the specific serving IMS node instance has failed.

During a UE registration, the proxy Internet protocol Multimedia Subsystem, IMS node sends a registration message to a second IMS node to select another serving IMS node instance to serve the UE based on a list of serving IMS node instances and their respective profiles comprised in the second IMS node.

According to another aspect, the object is achieved by a first Core Network, CN, node. The first CN node is configured to assist in selecting a serving Internet protocol Multimedia Subsystem, IMS, node instance to serve a User Equipment, UE, in a communications network. The first CN node is further configured to:
Send to a second CN node, a first subscription request to be informed about serving IMS node instances registered in the second CN node, which serving IMS node instances are arranged to operate in an IMS network in the communications network,
receive from the second CN node, a list of serving IMS node instances and their respective profiles, according to the subscription request, and
when the UE registers in the IMS network, send to a second IMS node the list of serving IMS node instances and their respective profiles, to assist the second IMS node in selecting a specific serving IMS node instance to serve the UE based on the list of serving IMS node instances and their respective profiles.

According to another aspect, the object is achieved by a second Core Network, CN, node. The second CN node is configured to assist in selecting a serving Internet protocol Multimedia Subsystem, IMS, node instance to serve a User Equipment, UE, in a communications network. The second CN node further being configured to:
Receive registration of a number of serving IMS node instances and their respective profile,
receive from a first CN node, a first subscription request to be informed about serving IMS node instances registered in the second CN node, and
send to the first CN node, a list of the registered serving IMS node instances and their respective profiles, according to the subscription request, enabling the first CN node, to assist a second IMS node in selecting a specific serving IMS node instance to serve the UE registered in the IMS network, based on the list of serving IMS node instances and their respective profiles.

According to another aspect, the object is achieved by a first serving Internet protocol Multimedia Subsystem, IMS, node instance. The first serving IMS node instance is configured to assist in selecting a specific serving Internet protocol Multimedia Subsystem, IMS, node instance to serve a User Equipment, UE, in a communications network. The first serving IMS node instance further being configured to:
Send to a second CN node a registration of the specific serving IMS node instance and its profile. The second CN node is arranged to inform a subscribing first CN node about the specific serving IMS node instance and its profile registered in the second CN node, enabling the first CN node, e.g. UDM/HSS, to assist a second IMS node in selecting a specific serving IMS node instance to serve the UE registered in the IMS network, based on a list of serving IMS node instances and their respective profiles comprising the specific serving IMS node instance and its profile.

According to another aspect, the object is achieved by a proxy Internet protocol Multimedia Subsystem, IMS node. The proxy IMS node is configured to assist in selecting a serving IMS node instance to serve a User Equipment, UE, in a communications network. The proxy IMS node is adapted to use a new serving IMS node instance. The proxy IMS node further being configured to:
When using a new selected specific serving IMS node instance send to a third Core Network, CN, node a third subscription request subscribes to be notified when the specific serving IMS node instance fails, and
receive from the third CN node a notification that the specific serving IMS node instance has failed,
during a UE registration, send a registration message to a second IMS node, to select another serving IMS node instance to serve the UE based on a list of serving IMS node instances and their respective profiles comprised in the second IMS node.

### BRIEF DESCRIPTION OF THE DRAWINGS

FIG. 1 is a schematic block diagram depicting embodiments of a communications network.

FIG. 2 is a flow chart depicting embodiments of a method performed by a first core network node.

FIG. 3 is a flow chart depicting embodiments of a method performed by a second core network node.

FIG. 4 is a flow chart depicting embodiments of a method performed by a first serving internet protocol multimedia subsystem (IMS) node instance.

FIG. 5 is a flow chart depicting embodiments of a method performed by a proxy IMS node.

FIG. 6 is a sequence diagram depicting embodiments of methods herein.

FIG. 7 is a sequence diagram depicting embodiments of methods herein.

FIG. 8 a and b are schematic block diagrams depicting embodiments of a first core network node.

FIG. 9 a and b are schematic block diagrams depicting embodiments of a second core network node.

FIG. 10 a and b are schematic block diagrams depicting embodiments of a first serving IMS node instance.

FIG. 11 a and b are schematic block diagrams depicting embodiments of a proxy IMS node.

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

### DETAILED DESCRIPTION

As mentioned above, an object of embodiments herein is to improve the performance of a communications network.

E.g., a discovery according to 5G solves the above-mentioned problem and also enables a definition of a set of NFs such as S-CFCF instances in this case, which allows any entity in a set-CFCF instances to take over immediately.

Examples of embodiments herein relate to S-CSCF Detection and Recovery.

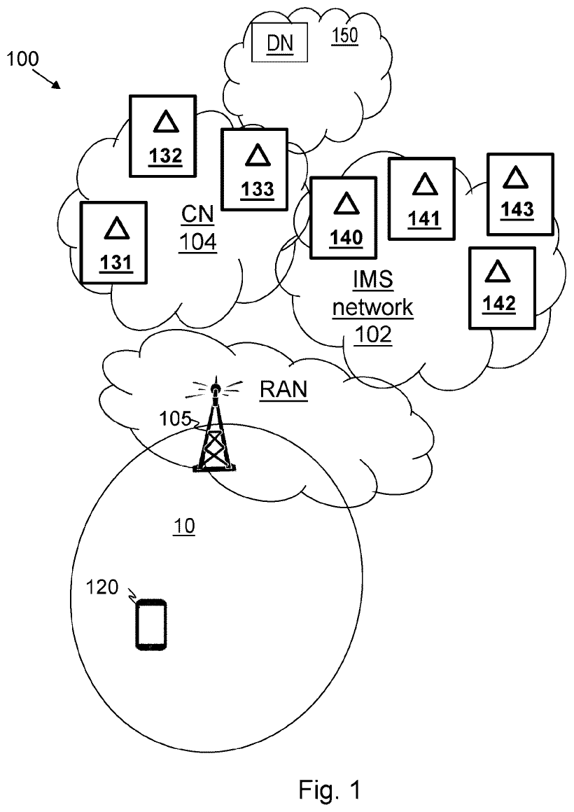

FIG. 1 is a schematic overview depicting a communications network 100 wherein embodiments herein may be implemented. The communications network 100 comprises one or more RANs, one or more IMS networks, e.g., the IMS network 102, and one or more CNs, e.g., the CN 104. The communications network 100 may use a number of different technologies, such as Wi-Fi, Long Term Evolution (LTE), LTE-Advanced, 5G, New Radio (NR), 6G, Wideband Code Division Multiple Access (WCDMA), Global System for Mobile communications/enhanced Data rate for GSM Evolution (GSM/EDGE), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g., WCDMA and LTE.

A number of RAN nodes operate in the communications network 100 such as e.g., a RAN node 105. The RAN network node 105 provides radio coverage in a number of cells which may also be referred to as a beam or a beam group of beams, such as a cell 10 provided by the RAN node 105.

The RAN node 105 may be any of an NG-RAN node, a transmission and reception point e.g., a base station, a radio access network node such as a Wireless Local Area Network (WLAN) access point or an Access Point Station (AP STA), an access controller, a base station, e.g., a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a UE 120 within the service area served by the network node 105 depending e.g., on the first radio access technology and terminology used. The network node 105 may be referred to as a serving network node and communicates with UEs such as the UE 120, with Downlink (DL) transmissions to the UE 120, and in Uplink (UL) transmissions from the UE 120.

A number of UEs operate in the communication network 100, such as e.g., the UE 120. The UE 120 may also be referred to as a UE, an IoT device, a mobile station, a non-access point (non-AP), a STA, and/or a wireless terminal. It should be understood by the skilled in the art that “UE” is a non-limiting term which means any terminal, wireless communication terminal, user equipment, Machine Type Communication (MTC) device, Device to Device (D2D) terminal, a radio device in a vehicle, or node e.g., smart phone, laptop, mobile phone, sensor, relay, mobile tablets or even a small base station communicating within a cell.

Some CN nodes operate in the CN network 104, e.g., a first CN node 131, a second CN node 131, and a third CN node 133.

The first CN node 131 may e.g., be a Unified Data Manager (UDM) node, also referred to as UDM, or a Home Subscriber Server (HSS) node also referred to as HSS.

The second CN node 132 may e.g., be a Network Repository Function (NRF) node also referred to as NRF.

The third CN node 133 may e.g., be a Policy Control Function (PCF) node, also referred to as PCF, or a Policy Control and Charging Rules Function (PCRF) node also referred to as PCRF.

Some IMS nodes operate in the IMS network 102, e.g., some serving IMS node instances 140, 141, a second IMS node 142, and a proxy IMS node 143.

The serving IMS node instances 140, 141 also referred to as serving IMS instances or S-CSCF instances, may e.g., be Serving(S)—Call Session Control Function (CSCF) (S-CSCF) nodes also referred to as S-CSCF.

The second IMS node 142, may e.g., be an Interrogating CSCF (I-CSCF) node also referred to as I-CSCF.

The proxy IMS node 143 may e.g., be a Proxy a CSCF (P-CSCF) node also referred to as P-CSCF.

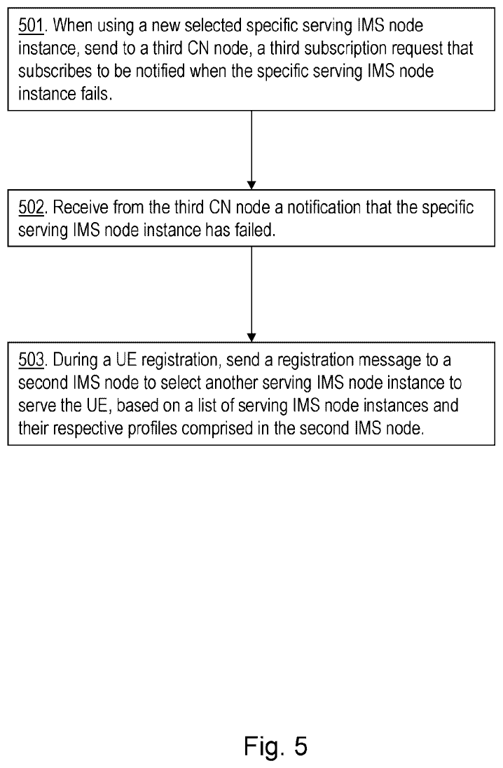

Methods herein may be performed by the first CN node 131, the second CN node 132, a serving IMS node instances 141, and the proxy IMS node 143. As an alternative, a Distributed Node (DN) and functionality, e.g., comprised in a cloud 150 as shown in FIG. 5, may be used for performing or partly performing the methods herein.

A number of embodiments will now be described, some of which may be seen as alternatives, while some may be used in combination. Embodiments of methods will be described in turn in view of the first CN node 131, the second CN node 132, the first serving IMS node instance 14 and the proxy IMS node 143.

### Method Performed by the First CN Node 131, e.g., HSS

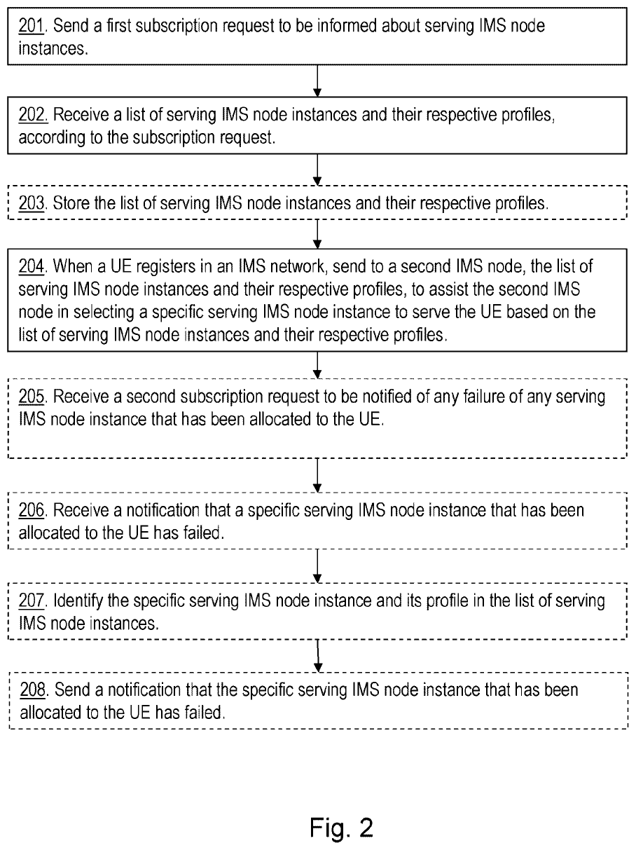

FIG. 2 shows example embodiments of a method performed by the first CN node 131, e.g., an UDM or an HSS node. The method is for assisting in selecting a serving IMS node instance 140, 141, e.g., an S-CSCF node, to serve the UE 120 in the communications network 100. The method comprises any one or more of the following actions, which actions may be taken in any suitable order. Actions that are optional are presented in dashed boxes in FIG. 2.

Action 201. The first CN node 131 sends a first subscription request to the second CN node 132, e.g., an NRF node. The first subscription request requests to be informed about serving IMS node instances 140, 141, e.g., S-CSCF, registered in the second CN node 132. The information about the serving IMS node instances 140, 141 may e.g. be used by the first CN node 131 to . get to now the different IMS instances available as well as the services they support as opposed to configuring this information in UDM/HSS. The serving IMS node instances 140, 141 are operating in the IMS network 102 in the communications network 100.

Action 202. The first CN node 131 receives a list from the second CN node 132. The list comprises serving IMS node instances 140, 141, e.g., S-CSCF instances, and their respective profiles, according to the subscription request.

Action 203. The first CN node 131 may store the list of serving IMS node instances 140, 141 e.g., S-CSCF, and their respective profiles, to e.g., be used later on.

Action 204. When the UE 120 registers in the IMS network 102, the first CN node 131 sends to the second IMS node 142, e.g., an I-CSCF node, the list of serving IMS node instances 140, 141, e.g., S-CSCF, and their respective profiles. The list of serving IMS node instances 140, 141, e.g., S-CSCF, and their respective profiles is sent to assist the second IMS node 142, e.g., an I-CSCF, in selecting a specific serving IMS node instance 141, e.g., S-CSCF, to serve the UE 120 based on the list of serving IMS node instances 140, 141 and their respective profiles.

Action 205. The first CN node 131 may receive a second subscription request from the third CN node 133, e.g., a PCF or PCRF node, also referred to as PCF/PCRF. The second subscription request relates to be notified of any failure of any serving IMS node 140, 141 instance, e.g., S-CSCF, that has been allocated to the UE 120.

Action 206. The first CN node 131 may receive a notification from the second CN node 132, e.g., NRF. The notification comprises that a specific serving IMS node 141 instance, e.g., S-CSCF instance, that has been allocated to the UE 120 has failed.

Action 207. The first CN node 131 may identify the specific serving IMS node 141 instance, e.g., S-CSCF instance, and its profile in the list of serving IMS node 140, 141 instances, e.g., S-CSCF instances.

Action 208. The first CN node 131 may send a notification to the third CN node 133, e.g., a PCF/PCRF. The notification notifies that the specific serving IMS node 141 instance, e.g., S-CSCF, that has been allocated to the UE 121 has failed. The notification enables the third CN node 132, e.g., a PCF/PCRF, to send the notification to the Proxy IMS node 143, e.g., a P-CSCF node, to arrange for selecting another serving IMS node 141 instance, e.g., S-CSCF.

Performing the above method in the first CN node 131 according to embodiments herein may bring the advantages of early detection and corrective action in case of node failure.

### Method Performed by the Second CN Node 132, e.g., NRF

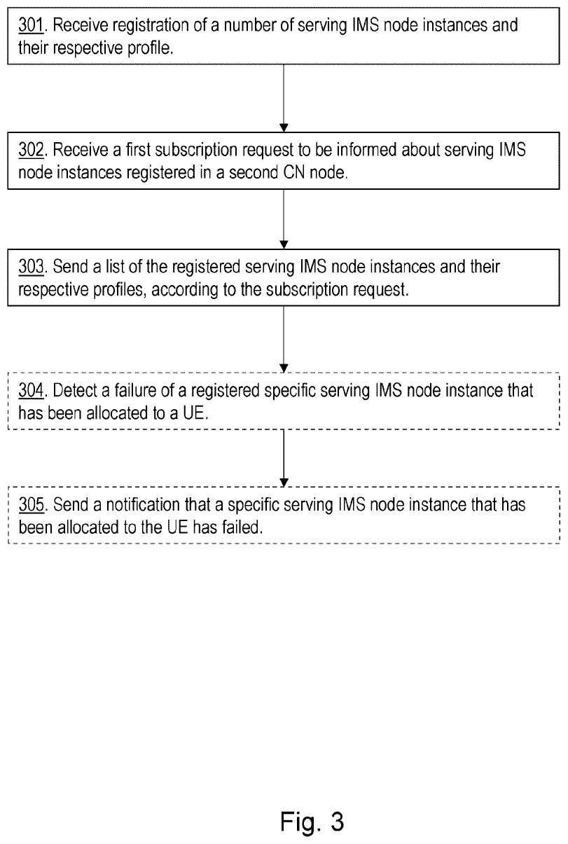

FIG. 3 shows example embodiments of a method performed by the second CN node 132, e.g., NRF. The method is for assisting in selecting a serving IMS node instance 140, 141, e.g., S-CSCF, to serve the UE 120 in the communications network 100. The method comprises any one or more of the following actions, which actions may be taken in any suitable order. Actions that are optional are presented in dashed boxes in FIG. 3.

Action 301. The second CN node 132 receives a registration of a number of serving IMS node instances 140, 141, e.g., S-CSCF, and their respective profile.

Action 302. The second CN node 132 receives the first subscription request from the first CN node 131, e.g., UDM/HSS. The first subscription request relates to be informed about serving IMS node instances 140, 141, e.g., S-CSCF, registered in the second CN node 132.

Action 303. The second CN node 132 sends a list to the first CN node 131, e.g., UDM/HSS. The list lists the registered serving IMS node instances 140, 141, e.g., S-CSCF, and their respective profiles, according to the subscription request. The list of the registered serving IMS node instances 140, 141, e.g., S-CSCF, and their respective profiles, sent to the first CN node 131 enables the first CN node 131, e.g., UDM/HSS, to e.g., assist the second IMS node 142, e.g., an I-CSCF, in selecting a specific serving IMS node instance 141, e.g., S-CSCF, to serve the UE 120 registered in the IMS network 102, based on the list of serving IMS node instances 140, 141 and their respective profiles.

Action 304. In an example scenario, the second CN node 132 detects a failure of a registered specific serving IMS node 140, 141 instance that has been allocated to the UE 120.

Action 305. The second CN node 132 may send a notification to the first CN node 131. The notification notifies that a specific serving IMS node 141 instance that has been allocated to the UE 120 has failed.

Performing the above method in the second CN node 132 according to embodiments herein may bring the advantages that any failure of an IMS node instance is immediately known and acted upon.

### Method Performed by the First Serving IMS Node Instance 141, e.g., S-CSCF

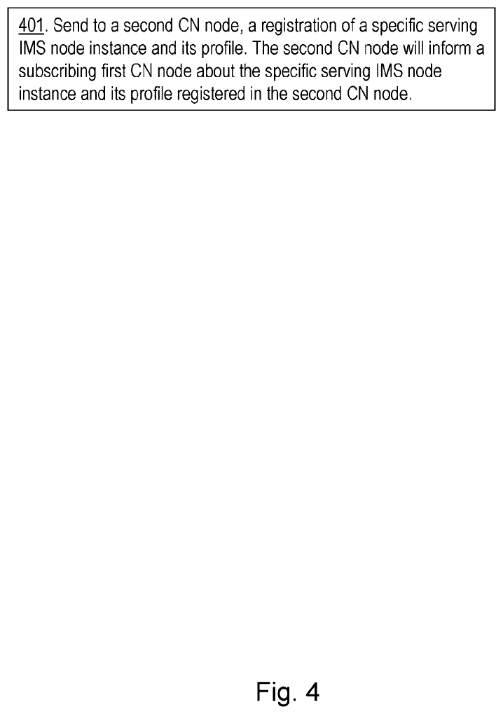

FIG. 4 shows example embodiments of a method performed by the first serving IMS node instance 141, e.g., S-CSCF. The method is for assisting in selecting a specific serving IMS node instance 140, 141, e.g., S-CSCF, to serve the UE 120 in the communications network 100. The method comprises any one or more of the following actions, which actions may be taken in any suitable order. Actions that are optional are presented in dashed boxes in FIG. 4.

Action 401. The first serving IMS node instance 141 sends a registration to the second CN node 132, e.g., NRF. The registration registrates the specific serving IMS node instance 141 and its profile.

The second CN node 132, e.g., NRF, is then enabled to inform the subscribing first CN node 131, e.g., UDM/HSS, about the specific serving IMS node instance 141 and its profile registered in the second CN node 132. In this way, the first CN node 131, e.g., UDM/HSS, may be enabled to assist a second IMS node 142, e.g., an I-CSCF, in selecting a specific serving IMS node instance 141, e.g., S-CSCF, to serve the UE 120 registered in the IMS network 102, based on a list of serving IMS node instances 140, 141 and their respective profiles comprising the specific serving IMS node instance 141 and its profile.

In some embodiments, any failure of the specific serving IMS node 140, 141 instance that has been allocated to the UE 120, will be detected by the second CN node 132, based on the registration sent 401 to the second CN node 132, e.g., NRF.

Performing the above method in the first serving IMS node instance 141 according to embodiments herein may bring the advantages that enables an early detection of failure of IMS nodes and allocation of new ones with no impact on performance.

### Method Performed by the Proxy IMS Node 143, e.g., P-CSCF

FIG. 5 shows example embodiments of a method performed by the proxy IMS node 143, e.g., a P-CSCF. The method is for assisting in selecting a serving IMS node instance 140, 141, e.g., S-CSCF, to serve the UE 120 in the communications network 100. The proxy IMS node 143 is using a new serving IMS node instance 141, this may mean newly selected and/or allocated serving IMS node instance 141. The method comprises any one or more of the following actions, which actions may be taken in any suitable order. Actions that are optional are presented in dashed boxes in FIG. 5.

Action 501. When using the new selected specific serving IMS node instance 141, e.g., S-CSCF, the proxy IMS node 143, sends a third subscription request to the third CN node 132, e.g., a PCF/PCRF. The third subscription request subscribes to the proxy IMS node 143, to be notified when the specific serving IMS node instance 141, e.g., S-CSCF, fails.

Action 502. The Proxy IMS node 143 receives a notification from the third CN node 133, e.g., a PCF/PCRF. The notification notifies that that the specific serving IMS node 141 instance, e.g., S-CSCF, has failed.

Action 502. During a UE 120 registration, i.e. when the UE 120 refreshes it IMS registration with the P-CSCF, the Proxy IMS node 143 sends a registration message to the second IMS node 142, e.g., an I-CSCF, to select another serving IMS node instance 140, e.g., S-CSCF, to serve the UE 120, based on a list of serving IMS node instances 140, 141 and their respective profiles comprised in the second IMS node 142. This is since the specific serving IMS node 141 instance, e.g., S-CSCF, has failed.

Performing the above method in the proxy IMS node 143 according to embodiments herein may bring the advantages that the UE registration process will not fail, and that the registration time is significantly reduced compared to what would happen without this approach.

It should be noted that the wordings S-CSCF node instance, S-CSCF node, and S-CSCF instance may be used interchangeably herein.

### Support for S-CSCF Discovery

According to embodiments herein, the first CN node 131, may utilize the the second CN node 132 to discover the serving IMS node instances 140, 141, and what they support as opposed to being provisioned with this information today. The second CN node 132, may provide the IP address or the serving IMS node instances and their profiles 140, 141, to the first CN node 131. The first CN node 131 includes this information to the second IMS node 142 as is the case today in 3 GPP 23.228 initial IMS Registration in the IMS network 102.

To enable that, the serving IMS node instances 140, 141 require to register their profiles in the second CN node 132.

The following information, this is just a subset, that may be registered by the serving IMS node instance 140, 141, in addition to what is required by the second CN node 132, to enable the second IMS node 142 to select an appropriate serving IMS node instance 140, 141.
A List of legacy services supported as defined in 3GPP TS 29.228 section 6.7.1
A List of new services, such a Augmented Reality, Artificial intelligence, and others.
Supported DNNs.
Supported S-NSSAI(s).

With examples the above may comprise that the first CN node 131, e.g., an UDM or an HSS node, may utilize the the second CN node 132, e.g., an NRF node, to discover the serving IMS node instances 140, 141, e.g., S-CSCF nodes, and what they support as opposed to being provisioned with this information today. The second CN node 132, e.g., an NRF node, may provide the IP address or the serving IMS node instances and their profiles 140, 141, e.g., S-CSCF nodes, to the first CN node 131, e.g., an UDM or an HSS node. The first CN node 131, e.g., an UDM or an HSS node, includes this information to the second IMS node 142, e.g., an I-CSCF node, as is the case today in 3 GPP 23.228 initial IMS Registration in the IMS network 102.

To enable that, the serving IMS node instances 140, 141, e.g., an S-CSCF nodes, require to register their profiles in the second CN node 132, e.g., an NRF node.

The following information, this is just a subset, that may be registered by the serving IMS node instance 140, 141, e.g., an S-CSCF node, in addition to what is required by the second CN node 132, e.g., the NRF node, Network Function, to enable the second IMS node 142, e.g., the I-CSCF node, to select an appropriate serving IMS node instance 140, 141, e.g., an S-CSCF node.
A List of legacy services supported as defined in 3GPP TS 29.228 section 6.7.1
A List of new services, such a Augmented Reality, Artificial intelligence, and others.
Supported DNNs.
Supported S-NSSAI(s).

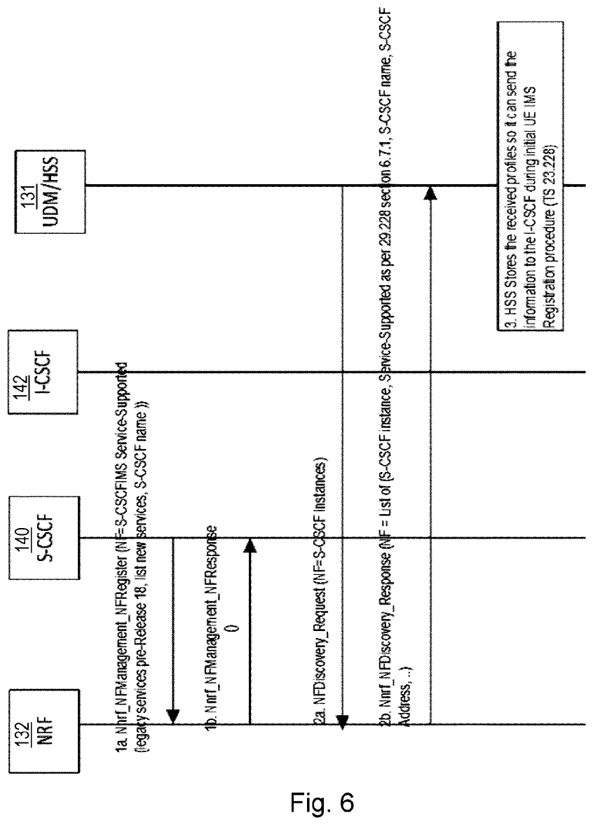

FIG. 6 illustrates a discovery procedure according to an example of embodiments herein. The following is a brief description of the steps in the call flow of FIG. 6:
In step 1a, every serving IMS node instance 140, 141, e.g., the S-CSCF node, registers its profile in the second CN node 132, e.g., the NRF node. This may e.g., be performed by initiating an Nnrf_NFManagement_NFRegister Request (NF=S-CSCFIMS, Service-Supported (legacy services 3GPP pre-Release 18 as defined in 29.228 section 6.7.1, list new services such as Augmented Reality, Artificial Intelligence, S-CSCF name, S-CSCF address, S-CSCF instance ID, etc.,)). This is similar to and may be combined with Action 401 described above.
In step 1b, the second CN node 132, e.g., the NRF node, send a response that is received by the respective serving IMS node instance 140, 141, e.g., the S-CSCF node.
In step 2a, the first CN node 131, e.g., the UDM or HSS node, subscribes to the second CN node 132, e.g., the NRF node, to be informed of serving IMS node instance 140, 141, e.g., an S-CSCF nodes instances. This may be done at any time by the first CN node 131, e.g., the UDM or HSS node. This is similar to and may be combined with Actions 201 and 302 described above.
In step 2b, the response is received and includes lists of serving IMS node instance 140, 141, e.g., the S-CSCF node instances, and their profiles. This is similar to and may be combined with Actions 202 and 302 described above.
In step 3, the first CN node 131, e.g., the UDM or HSS node, stores this information and uses it during an IMS registration of the UE 120, based on 3GPP 23.228, to aid the second IMS node 142, e.g., the I-CSCF node, in selecting a specific serving IMS node instance 140, 141, e.g., the S-CSCF node, for a UE such as the UE 120. This is similar to and may be combined with Action 203 described above.

### S-CSCF Recovery

Due to its support for the second CN node 132, e.g., the NRF node, to discover a serving IMS node instance 140, 141, e.g., S-CSCF node, the first CN node 131, e.g., the UDM or HSS node, will be informed if new serving IMS node instances 140, 141, e.g., S-CSCF nodes, are put in service or removed out of service to update its stored information.

If the first CN node 131, e.g., the UDM or HSS node, is informed of a serving IMS node instance 140, 141, e.g., S-CSCF node instance, failure it may inform impacted Proxy IMS nodes 143, e.g., P-CSCF nodes. When the first CN node 131, e.g., the UDM or HSS node, is informed of the serving IMS node instance 140, 141, e.g., an S-CSCF node, failure by the Proxy IMS node 143, e.g., the P-CSCF node. The Proxy IMS node 143, e.g., the P-CSCF node may then during a UE IMS Registration refresh, such as the UE 120, registration be able to send a Registration message immediately to the second IMS node 142, e.g., the I-CSCF node, so it is enabled to select a new serving IMS node instance 140, 141, e.g., an S-CSCF node, hence reducing the registration time considerably.

This behavior of selecting a new serving IMS node instance 140, 141, e.g., an S-CSCF node, if one fails, happens in all cases with the difference that, as in prior art in the case the a P-CSCF node is not aware of an S-CSCF failure than it tries to reach the UE allocated S-CSCF instance and will have to wait for transaction to timeout before sending the SIP Register Request to the I-CSCF. This is overcome by the embodiments of the methods herein.

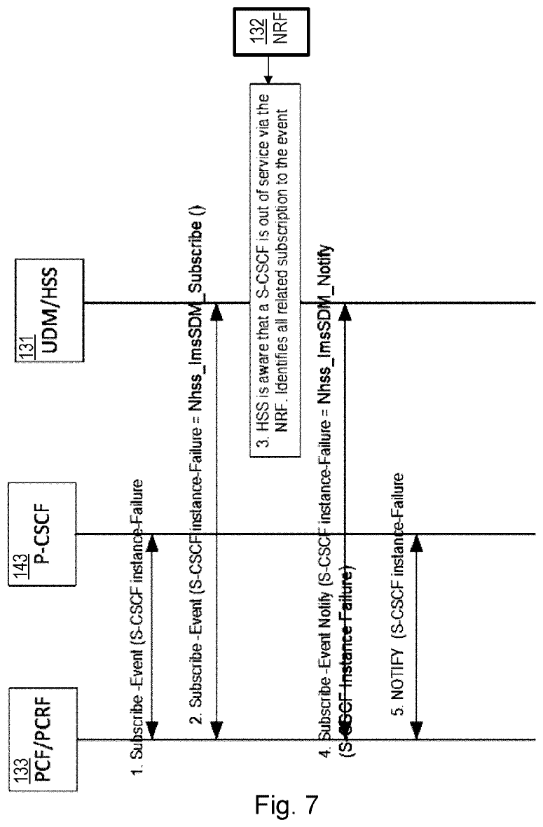

FIG. 7 illustrates how the Proxy IMS node 143, e.g., the P-CSCF node, is notified of a failed serving IMS node instance 140, 141, e.g., S-CSCF node instance, allocated for UEs such as the UE 120. The steps in the call flow may be as follows:
In step 1, every Proxy IMS node, such as the Proxy IMS node 143, e.g., the P-CSCF node, using a new selected serving IMS node instance 140, 141, e.g., the S-CSCF node, subscribes to the the third CN node 133, e.g., the PCF or PCRF node, to be notified when the serving IMS node instance 140, 141, e.g., the S-CSCF node, has failed. The Proxy IMS node 143, e.g., the P-CSCF node, subscribes only once for every new serving IMS node instance 140, 141, e.g., an S-CSCF instance, selected during a UE IMS registration. This is similar to and may be combined with Action 501 described above.
In step 2, the the third CN node 133, e.g., the PCF or PCRF node, subscribes to the first CN node 131, e.g., the UDM or HSS node, to be notified of any failure to any serving IMS node instance 140, 141, e.g., S-CSCF node instance, that has been allocated to a UE such as the UE 120. This may be a new event added to the 3GPP message Nhss_ImsSDM_Subscribe, which is exclusively used to report a change in the subscribe profile by HSS such as the the first CN node 131. It may also be a completely new SUBSCRIBE/NOTIFY procedure. So more than one option is available. This is similar to and may be combined with Action 205 described above.
In step 3 HSS is aware from the second CN node 132, e.g., the NRF node, that a serving IMS node instance 140, 141, e.g., an S-CSCF instance, allocated to IMS subscribers failed. There is a need now to inform all Proxy IMS nodes, e.g., P-CSCF nodes, such as the Proxy IMS node 143, that uses this failed serving IMS node instance 140, 141, e.g., S-CSCF node. This is similar to and may be combined with Actions 206, 304 and 305 described above.
In step 4, the first CN node 131, e.g., an UDM or an HSS node, informs the third CN node 133, e.g., the PCF or PCRF node of a failed serving IMS node instance 140, 141, e.g., S-CSCF node, due a subscription initiated by the third CN node 133, e.g., the PCF or PCRF node. This is similar to and may be combined with Action 208 described above.
In step 5, the third CN node 133, e.g., the PCF or PCRF node, informs the subscribing Proxy IMS node 143, e.g., the P-CSCF node about the failed serving IMS node instance 140, 141, e.g., the S-CSCF node. The Proxy IMS node 143, e.g., the P-CSCF node may store this information to make use of it when IMS subscribers refreshing their IMS registrations have been allocated a failed serving IMS node instance 140, 141, e.g., the S-CSCF node, so the Proxy IMS node 143, e.g., a P-CSCF node is enabled to immediately send the IMS Registration to the second IMS node 142, e.g., an I-CSCF node. This is similar to and may be combined with Action 502 described above.

A few things to note with regard for some options supporting the above procedure e.g., comprises:

The Proxy IMS node 143, e.g., a P-CSCF node, subscribes with the third CN node 133, e.g., the PCF or PCRF node, only once to the serving IMS node instance 140, 141, e.g., an S-CSCF node, allocated to a UE such as the UE 120.

The Proxy IMS node 143, e.g., a P-CSCF node may or may not include the serving IMS node instance 140, 141, e.g., S-CSCF node, of interest during a subscription. If the Proxy IMS node 143, e.g., the P-CSCF node did not include the serving IMS node instance 140, 141, e.g., the S-CSCF node, it is interested in, it will receive notifications from the from the third CN node 133, e.g., the PCF or PCRF node for other instances that it may not recognize which it can ignore.

P-CSCFs such as the Proxy IMS node 143, e.g., a P-CSCF node, may not need to explicitly subscribe to failed serving IMS node instances 140, 141, e.g., an S-CSCF nodes. Instead, the third CN node 133, e.g., the PCF or PCRF node, may assume an implicit subscription when it communicates with a Proxy IMS node 143, e.g., a P-CSCF node during a course of an IMS session. In this case, the the third CN node 133, e.g., the PCF or PCRF node may subscribe with the first CN node 131, e.g., the UDM or HSS node, to all failed serving IMS node instances 140, 141, e.g., an S-CSCF nodes, and report them to all P-CSCFs such as the Proxy IMS node 143, it has had a communication with. The Proxy IMS node 143, e.g., a P-CSCF node e.g., has to be prepared however to handle a notification.

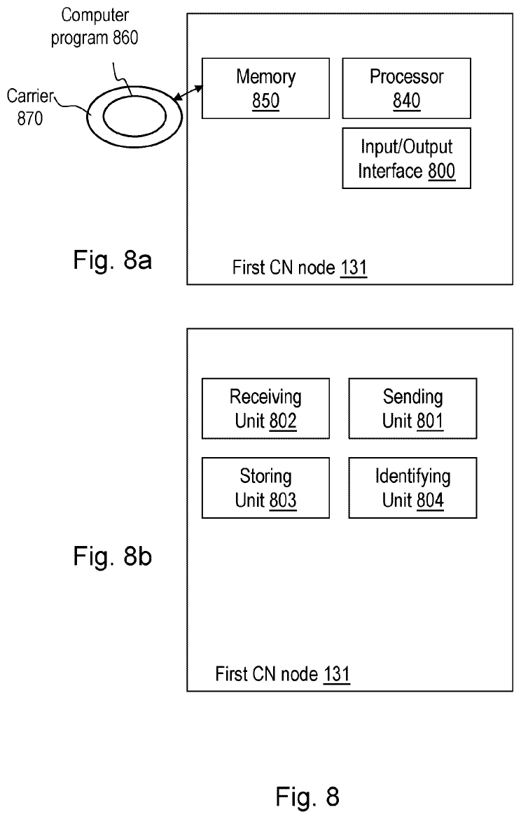

To perform the method actions above, the first CN node 131 may comprise an arrangement depicted in FIG. 8a and b. The first CN node 131 is configured to assist in selecting a serving IMS node instance 140, 141, e.g., S-CSCF, to serve the UE 120 in the communications network 100.

The first CN node 131 may comprise an input and output interface 800 configured to communicate with any suitable entity described herein. The input and output interface 800 may comprise a wireless receiver not shown, and a wireless transmitter not shown.

The first CN node 131 may further comprise a sending unit 801, a receiving unit 802, a storing unit 803, and an identifying unit 804. The units are described more below under Embodiments.

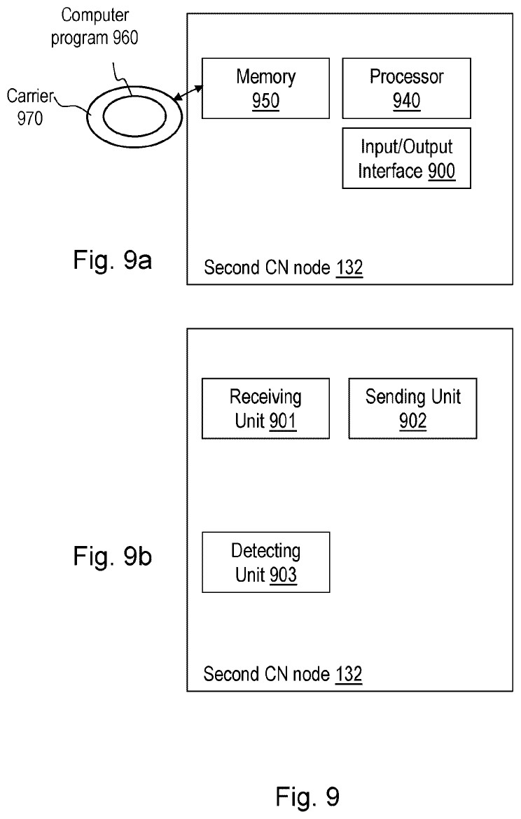

To perform the method actions above, the second CN node 132 may comprise an arrangement depicted in FIG. 9a and b. The second CN node 132 node is configured to assist in selecting a serving IMS node instance 140, 141, e.g., S-CSCF, to serve the UE 120 in the communications network 100.

The second CN node 132 may comprise an input and output interface 900 configured to communicate with any suitable entity described herein. The input and output interface may comprise a wireless receiver not shown, and a wireless transmitter not shown.

The second CN node 132 may further comprise a receiving unit 901 a sending unit 902, and a detecting unit 903. The units are described more below under Embodiments.

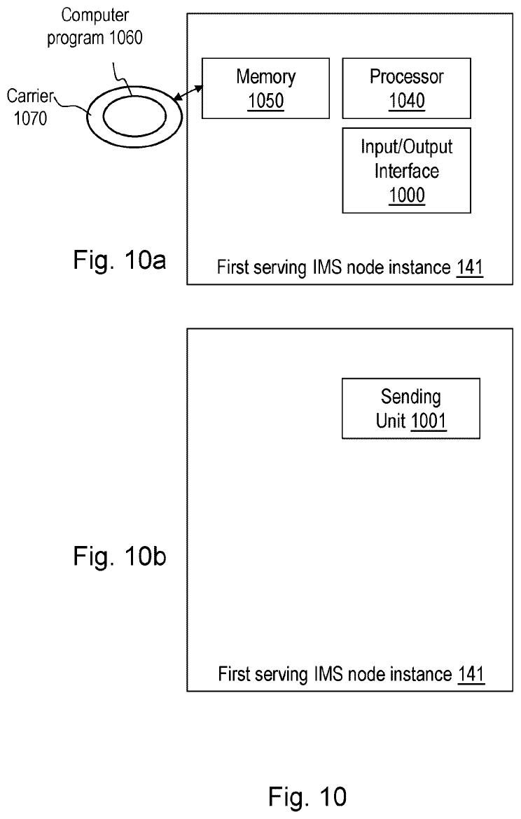

To perform the method actions above, the first serving IMS node instance 141 may comprise an arrangement depicted in FIG. 10a and b. The first serving IMS node instance 141 is configured to assist in selecting a specific serving IMS node instance 140, 141, e.g., S-CSCF, to serve the UE 120 in the communications network 100.

The first serving IMS node instance 141 may comprise an input and output interface 1000 configured to communicate with any suitable entities described herein. The input and output interface may e.g., comprise a wireless receiver (not shown) and a wireless transmitter (not shown).

The first serving IMS node instance 141 may further comprise a sending unit 1000. The unit is described more below under Embodiments.

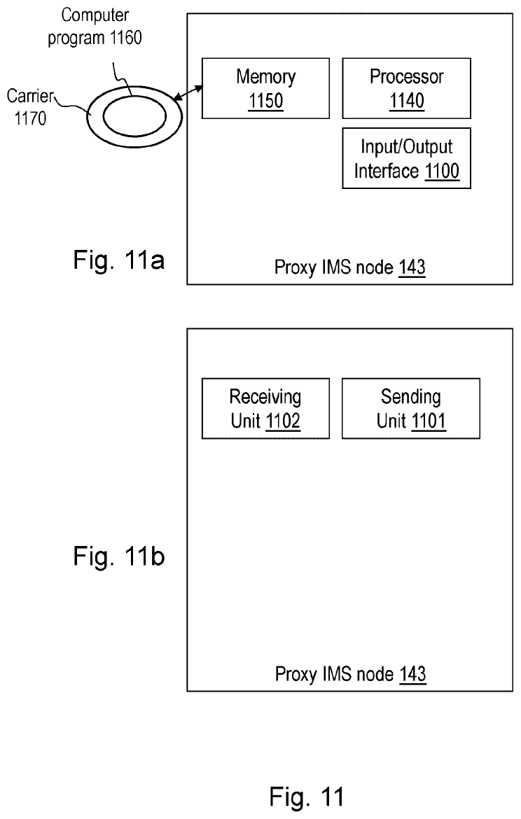

To perform the method actions above, the proxy IMS node 143 may comprise an arrangement depicted in FIG. 11a and b. The proxy IMS node 143 is configured to assist in selecting a serving IMS node instance 140, 141, e.g., S-CSCF, to serve the UE 120 in the communications network 100. The proxy IMS node 143 is using a new serving IMS node instance 141.

The proxy IMS node 143 may comprise an input and output interface 1100 configured to communicate with any suitable entities described herein. The input and output interface may e.g., comprise a wireless receiver (not shown) and a wireless transmitter (not shown).

The proxy IMS node 143 may further comprise a sending unit 1101 and a receiving unit 1101. The units are described more below under Embodiments.

The embodiments herein may be implemented through a respective processor or respective one or more processors, such as any one or more out of a processor 840 of a processing circuitry in the first CN node 131 depicted in FIG. 8a, a processor 940 of a processing circuitry in the second CN node 132 depicted in FIG. 9a, a processor 1040 of a processing circuitry in the first serving IMS node instance 141 depicted in FIG. 10a, and a processor 1140 of a processing circuitry in the proxy IMS node 143 depicted in FIG. 11a.

The embodiments herein may be implemented together with respective computer program code for performing the functions and actions of the embodiments herein. The respective program code mentioned above may also be provided as a computer program product, for instance in the form of a data carrier carrying computer program code for performing the embodiments herein when being loaded into a respective node or node instance. One such carrier may be in the form of a CD ROM disc. It is however feasible with other data carriers such as a memory stick. The respective computer program code may furthermore be provided as pure program code on a server and downloaded to any one or more out of the respective first CN node 131, the second CN node 132, the first serving IMS node instance 141, and the proxy IMS node 143.

Any one or more out of the first CN node 131, the second CN node 132, the first serving IMS node instance 141, and the proxy IMS node 143, may further comprise respective memories 850, 950, 1050, 1150, comprising one or more respective memory units. The respective memories 850, 950, 1050, 1150, may comprise respective instructions executable by the respective processor in the first CN node 131, the second CN node 132, the first serving IMS node instance 141, and the proxy IMS node 143. The respective memories 850, 950, 1050, 1150 are arranged to be used to store respective e.g., information, indications, data, configurations, communication data, and applications to perform the methods herein when being executed in the respective first CN node 131, second CN node 132, first serving IMS node instance 141, and proxy IMS node 143.

In some embodiments, respective computer programs 860, 960, 1060, 1160 comprise instructions, which when executed by the respective at least one processor 840, 940, 1040, 1140, cause the respective at least one processor of the respective first CN node 131, second CN node 132, first serving IMS node instance 141, and proxy IMS node 143 to perform the actions above.

In some embodiments, respective carriers 870, 970, 1070, 1170 comprise the respective computer programs 860, 960, 1060, 1160 wherein the respective carriers 870, 970, 1070, 1170 is one of an electronic signal, an optical signal, an electromagnetic signal, a magnetic signal, an electric signal, a radio signal, a microwave signal, or a computer-readable storage medium.

Those skilled in the art will appreciate that the units in the respective first CN node 131, second CN node 132, first serving IMS node instance 141, and proxy IMS node 143 described above may refer to a combination of analog and digital circuits, and/or one or more processors configured with software and/or firmware, e.g., stored in the respective the respective first CN node 131, second CN node 132, first serving IMS node instance 141, and proxy IMS node 143, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a system-on-a-chip SoC.

### EMBODIMENTS

Below, some example embodiments 1-24 are shortly described. See e.g., FIGS. 2, 3, 4, 5, 6, 7, 8a, 8b, 9a, 9b, 10a, 10b, 11a, and 11b.

Embodiment 1. A method performed by a first Core Network, CN, node 131, e.g., UDM/HSS, e.g., for assisting in selecting a serving Internet protocol Multimedia Subsystem, IMS, node instance 140, 141, e.g., S-CSCF, to serve a User Equipment, UE, 120 in a communications network 100, the method comprising any one or more out of:
sending 201 to a second CN node 132, e.g., NRF, a first subscription request to be informed about serving IMS node instances 140, 141, e.g., S-CSCF, registered in the second CN node 132, which serving IMS node instances 140, 141 are operating in an IMS network 102 in the communications network 100,
receiving 202 from the second CN node 132 a list of serving IMS node instances 140, 141, e.g., S-CSCF, and their respective profiles, according to the subscription request,
when the UE 120 registers in the IMS network 102, sending 204 to a second IMS node 142, e.g., an I-CSCF, the list of serving IMS node instances 140, 141, e.g., S-CSCF, and their respective profiles, to assist the second IMS node 142, e.g., an I-CSCF, in selecting a specific serving IMS node instance 141, e.g., S-CSCF, to serve the UE 120 based on the list of serving IMS node instances 140, 141 and their respective profiles.

Embodiment 2. The method according to Embodiment 1, further comprising:
storing 203 the list of serving IMS node instances 140, 141 e.g., S-CSCF, and their respective profiles.

Embodiment 3. The method according to any of the Embodiments 1-2, further comprising:
receiving 205 from a third CN node 133, e.g., a PCF/PCRF, a second subscription request to be notified of any failure of any serving IMS node 140, 141 instance, e.g., S-CSCF, that has been allocated to a UE 120,
receiving 206 from the second CN node 132, e.g., NRF, a notification that a specific serving IMS node 141 instance, e.g., S-CSCF, that has been allocated to the UE 120 has failed,
identifying 207 the specific serving IMS node 141 instance, e.g., S-CSCF, and its profile in the list of serving IMS node 140, 141 instances, e.g., S-CSCF,
sending 208 to the third CN node 133, e.g., a PCF/PCRF, a notification that the specific serving IMS node 141 instance, e.g., S-CSCF, that has been allocated to the UE 121 has failed, which notification enables the third CN node 132, e.g., a PCF/PCRF, to send the notification to a Proxy IMS node 143, e.g., a P-CSCF, to arrange for selecting another serving IMS node 141 instance, e.g., S-CSCF.

Embodiment 4. A computer program 860 comprising instructions, which when executed by a processor 840, causes the processor 840 to perform actions according to any of the Embodiments 1-3.

Embodiment 5. A carrier 870 comprising the computer program 860 of Embodiment 4, wherein the carrier 870 is one of an electronic signal, an optical signal, an electromagnetic signal, a magnetic signal, an electric signal, a radio signal, a microwave signal, or a computer-readable storage medium.

Embodiment 6. A method performed by a second Core Network, CN, node 132, e.g., NRF, for assisting in selecting a serving Internet protocol Multimedia Subsystem, IMS, node instance 140, 141, e.g., S-CSCF, to serve a User Equipment, UE, 120 in a communications network 100, the method comprising any one or more out of:
receiving 301 registration of a number of serving IMS node instances 140, 141, e.g., S-CSCF, and their respective profile,
receiving 302 from a first CN node 131, e.g., UDM/HSS, a first subscription request to be informed about serving IMS node instances 140, 141, e.g., S-CSCF, registered in the second CN node 132,
sending 303 to the first CN node 131, e.g., UDM/HSS, a list of the registered serving IMS node instances 140, 141, e.g., S-CSCF, and their respective profiles, according to the subscription request, e.g., enabling the first CN node 131, e.g., UDM/HSS, to assist a second IMS node 142, e.g., an I-CSCF, in selecting a specific serving IMS node instance 141, e.g., S-CSCF, to serve the UE 120 registered in the IMS network 102, based on the list of serving IMS node instances 140, 141 and their respective profiles.

Embodiment 7. The method according to Embodiment 6, further comprising:
detecting 304 a failure of a registered specific serving IMS node 140, 141 instance that has been allocated to a UE 120,
sending 305 to the first CN node 131, a notification that a specific serving IMS node 141 instance that has been allocated to the UE 120 has failed.

Embodiment 8. A computer program 960 comprising instructions, which when executed by a processor 940, causes the processor 940 to perform actions according to any of the Embodiments 6-7.

Embodiment 9. A carrier 970 comprising the computer program 960 of Embodiment 8, wherein the carrier 970 is one of an electronic signal, an optical signal, an electromagnetic signal, a magnetic signal, an electric signal, a radio signal, a microwave signal, or a computer-readable storage medium.

Embodiment 10. A method performed by a first serving Internet protocol Multimedia Subsystem, IMS, node instance 141, e.g., S-CSCF, for assisting in selecting a specific serving Internet protocol Multimedia Subsystem, IMS, node instance 140, 141, e.g., S-CSCF, to serve a User Equipment, UE, 120 in a communications network 100, the method comprising any one or more out of:
sending 401 to a second CN node 132, e.g., NRF, a registration of the specific serving IMS node instance 141 and its profile,
which second CN node 132, e.g., NRF, will inform a subscribing first CN node 131, e.g., UDM/HSS, about the specific serving IMS node instance 141 and its profile registered in the second CN node 132, enabling the first CN node 131, e.g., UDM/HSS, to assist a second IMS node 142, e.g., an I-CSCF, in selecting a specific serving IMS node instance 141, e.g., S-CSCF, to serve the UE 120 registered in the IMS network 102, based on a list of serving IMS node instances 140, 141 and their respective profiles comprising the specific serving IMS node instance 141 and its profile.

Embodiment 11. The method according to Embodiment 10, wherein:
any failure of the specific serving IMS node 140, 141 instance that has been allocated to a UE 120, will be detected by the second CN node 132, based on the registration sent 401 to the second CN node 132, e.g., NRF.

Embodiment 12. A computer program 1060 comprising instructions, which when executed by a processor 1040, causes the processor 1040 to perform actions according to any of the Embodiments 10-11.

Embodiment 13. A carrier 1070 comprising the computer program 1060 of Embodiment 12, wherein the carrier 1070 is one of an electronic signal, an optical signal, an electromagnetic signal, a magnetic signal, an electric signal, a radio signal, a microwave signal, or a computer-readable storage medium.

Embodiment 14. A method performed by a proxy Internet protocol Multimedia Subsystem, IMS node 143, e.g., a P-CSCF, for assisting in selecting a serving IMS node instance 140, 141, e.g., S-CSCF, to serve a User Equipment, UE, 120 in a communications network 100, wherein the proxy IMS node 143 is using a new serving IMS node instance 141, the method comprising any one or more out of:
when using a new selected specific serving IMS node instance 141, e.g., S-CSCF, sending 501 to a third Core Network, CN, node 132, e.g., a PCF/PCRF, a third subscription request subscribes to be notified when the specific serving IMS node instance 141, e.g., S-CSCF, fails, and
receiving 502 from the third CN node 133, e.g., a PCF/PCRF, a notification that the specific serving IMS node 141 instance, e.g., S-CSCF, has failed,
during a UE 120 registration, sending 503 a registration message to a second IMS node 142, e.g., an I-CSCF, to select another serving IMS node instance 140, e.g., S-CSCF, to serve the UE 120 based, on a list of serving IMS node instances 140, 141 and their respective profiles comprised in the second IMS node 142.

Embodiment 15. A computer program 1160 comprising instructions, which when executed by a processor 1140, causes the processor 1140 to perform actions according to any of Embodiment 14.

Embodiment 16. A carrier 1170 comprising the computer program 1160 of Embodiment 15, wherein the carrier 1170 is one of an electronic signal, an optical signal, an electromagnetic signal, a magnetic signal, an electric signal, a radio signal, a microwave signal, or a computer-readable storage medium.

Embodiment 17. A first Core Network, CN, node 131, e.g., UDM/HSS, e.g., configured to assist in selecting a serving Internet protocol Multimedia Subsystem, IMS, node instance 140, 141, e.g., S-CSCF, to serve a User Equipment, UE, 120 in a communications network 100, the first CN node 131 further being configured to any one or more out of:
send, e.g., by means of a sending unit 801 comprised in the first CN node 131, to a second CN node 132, e.g., NRF, a first subscription request to be informed about serving IMS node instances 140, 141, e.g., S-CSCF, registered in the second CN node 132, which serving IMS node instances 140, 141 are arranged to operate in an IMS network 102 in the communications network 100,
receive, e.g., by means of a receiving unit 802 comprised in the first CN node 131, from the second CN node 132 a list of serving IMS node instances 140, 141, e.g., S-CSCF, and their respective profiles, according to the subscription request, and
when the UE 120 registers in the IMS network 102, send, e.g., by means of the sending unit 801 comprised in the first CN node 131, to a second IMS node 142, e.g., an I-CSCF, the list of serving IMS node instances 140, 141, e.g., S-CSCF, and their respective profiles, to assist the second IMS node 142, e.g., an I-CSCF, in selecting a specific serving IMS node instance 141, e.g., S-CSCF, to serve the UE 120 based on the list of serving IMS node instances 140, 141 and their respective profiles.

Embodiment 18. the first CN node 131 according to Embodiment 17, further configured to:
store, e.g., by means of a storing unit 803 comprised in the first CN node 131, the list of serving IMS node instances 140, 141 e.g., S-CSCF, and their respective profiles.

Embodiment 19. the first CN node 131 according to any of the Embodiments 17-18, further configured to:
receive, e.g., by means of the receiving unit 802 comprised in the first CN node 131, from a third CN node 133, e.g., a PCF/PCRF, a second subscription request to be notified of any failure of any serving IMS node 140, 141 instance, e.g., S-CSCF, that has been allocated to a UE 120,
receive, e.g., by means of the receiving unit 802 comprised in the first CN node 131, from the second CN node 132, e.g., NRF, a notification that a specific serving IMS node 141 instance, e.g., S-CSCF, allocated to the UE 120 has failed,
identify, e.g., by means of an identifying unit 804 comprised in the first CN node 131, the specific serving IMS node 141 instance, e.g., S-CSCF, and its profile in the list of serving IMS node 140, 141 instances, e.g., S-CSCF,
send, e.g., by means of the sending unit 801 comprised in the first CN node 131, to the third CN node 133, e.g., a PCF/PCRF, a notification that the specific serving IMS node 141 instance, e.g., S-CSCF, that has been allocated to the UE 121 has failed, which notification is adapted to enable the third CN node 132, e.g., a PCF/PCRF, to send the notification to a Proxy IMS node 143, e.g., a P-CSCF, to arrange for selecting another serving IMS node 141 instance, e.g., S-CSCF.

Embodiment 20. A second Core Network, CN, node 132, e.g., NRF, configured to assist in selecting a serving Internet protocol Multimedia Subsystem, IMS, node instance 140, 141, e.g., S-CSCF, to serve a User Equipment, UE, 120 in a communications network 100, the second CN node 132 further being configured to any one or more out of:
receive, e.g., by means of a receiving unit 901 comprised in the second CN node 132, registration of a number of serving IMS node instances 140, 141, e.g., S-CSCF, and their respective profile,
receive, e.g., by means of the receiving unit 901 comprised in the second CN node 132, from a first CN node 131, e.g., UDM/HSS, a first subscription request to be informed about serving IMS node instances 140, 141, e.g., S-CSCF, registered in the second CN node 132,
send, e.g., by means of a sending unit 902 comprised in the second CN node 132, to the first CN node 131, e.g., UDM/HSS, a list of the registered serving IMS node instances 140, 141, e.g., S-CSCF, and their respective profiles, according to the subscription request, e.g., enabling the first CN node 131, e.g., UDM/HSS, to assist a second IMS node 142, e.g., an I-CSCF, in selecting a specific serving IMS node instance 141, e.g., S-CSCF, to serve the UE 120 registered in the IMS network 102, based on the list of serving IMS node instances 140, 141 and their respective profiles.

Embodiment 21. the second CN node 132 according to Embodiment 20, further configured to:
detect, e.g., by means of a detecting unit 903 comprised in the second CN node 132, a failure of a registered specific serving IMS node 140, 141 instance that has been allocated to a UE 120,
send, e.g., by means of the sending unit 902 comprised in the second CN node 132, to the first CN node 131, a notification that a specific serving IMS node 141 instance that has been allocated to the UE 120 has failed.

Embodiment 22. A first serving Internet protocol Multimedia Subsystem, IMS, node instance 141, e.g., S-CSCF, configured to assist in selecting a specific serving Internet protocol Multimedia Subsystem, IMS, node instance 140, 141, e.g., S-CSCF, to serve a User Equipment, UE, 120 in a communications network 100, the first serving IMS node instance 141 further being configured to any one or more out of:
send, e.g., by means of a sending unit 1001 comprised in the first serving IMS node instance 141, to a second CN node 132, e.g., NRF, a registration of the specific serving IMS node instance 141 and its profile,
which second CN node 132, e.g., NRF, is arranged to inform a subscribing first CN node 131, e.g., UDM/HSS, about the specific serving IMS node instance 141 and its profile registered in the second CN node 132, enabling the first CN node 131, e.g., UDM/HSS, to assist a second IMS node 142, e.g., an I-CSCF, in selecting a specific serving IMS node instance 141, e.g., S-CSCF, to serve the UE 120 registered in the IMS network 102, based on a list of serving IMS node instances 140, 141 and their respective profiles comprising the specific serving IMS node instance 141 and its profile.

Embodiment 23. the first serving IMS node instance 141 according to Embodiment 22, wherein:
any failure of the specific serving IMS node 140, 141 instance that has been allocated to the UE 120, is arranged to be detected by the second CN node 132, based on the registration sent to the second CN node 132, e.g., NRF.

Embodiment 24. A proxy Internet protocol Multimedia Subsystem, IMS node 143, e.g., a P-CSCF, configured to assist in selecting a serving IMS node instance 140, 141, e.g., S-CSCF, to serve a User Equipment, UE, 120 in a communications network 100, wherein the proxy IMS node 143 is adapted to use a new serving IMS node instance 141, the proxy IMS node 143 further being configured to any one or more out of:
when using a new selected specific serving IMS node instance 141, e.g., S-CSCF, send, e.g., by means of a sending unit 1101 comprised in the proxy IMS node 143, to a third Core Network, CN, node 132, e.g., a PCF/PCRF, a third subscription request subscribes to be notified when the specific serving IMS node instance 141, e.g., S-CSCF, fails, and
receive, e.g., by means of a receiving unit 1102 comprised in the proxy IMS node 143, from the third CN node 133, e.g., a PCF/PCRF, a notification that the specific serving IMS node 141 instance, e.g., S-CSCF, has failed,
during a UE 120 registration, send, e.g., by means of the sending unit 1101 comprised in the proxy IMS node 143, a registration message to a second IMS node 142, e.g., an I-CSCF, to select another serving IMS node instance 140, e.g., S-CSCF, to serve the UE 120 based, on a list of serving IMS node instances 140, 141 and their respective profiles comprised in the second IMS node 142.

### Further Extensions and Variations

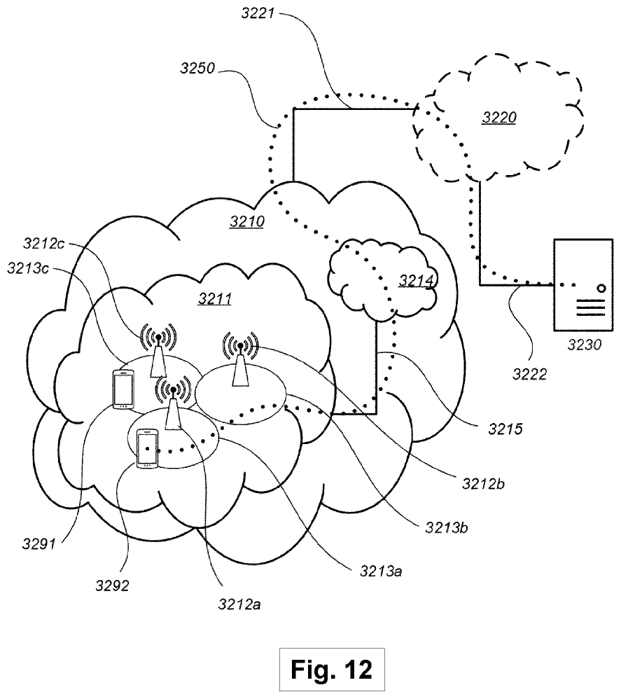

With reference to FIG. 12, in accordance with an embodiment, a communication system includes a telecommunication network 3210, such as a 3GPP-type cellular network, e.g., the communications network 100, which comprises an access network 3211, such as a radio access network, and a core network 3214, e.g., the communications network 100 and/or the IMS network 102. The access network 3211 comprises a plurality of base stations 3212a, 3212b, 3212c, such as the RAN node 105, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as the UE 120 and/or a Non-AP STA 3291 located in coverage area 3213c is configured to wirelessly connect to, or be paged by, the corresponding base station 3212c. A second UE 3292 such as the UE 120 and/or a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

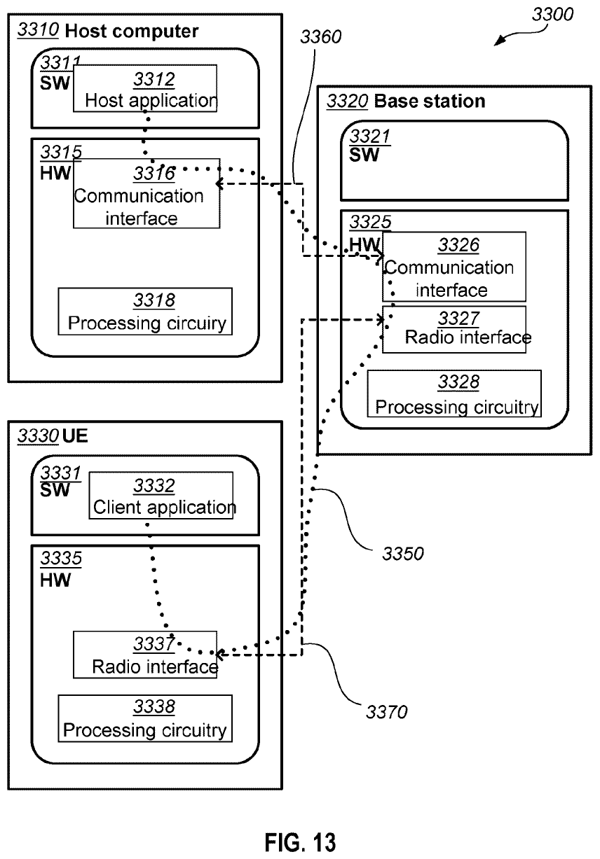

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to setup and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to setup and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: e.g., any of data rate, latency, and power consumption, and thereby provide benefits such as corresponding effect on the OTT service: e.g., any of reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc. ; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

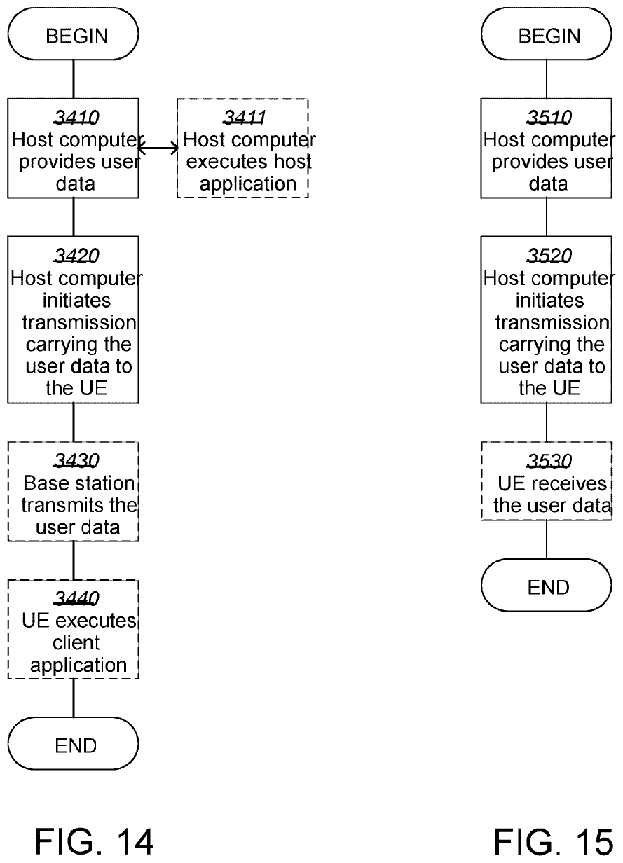

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

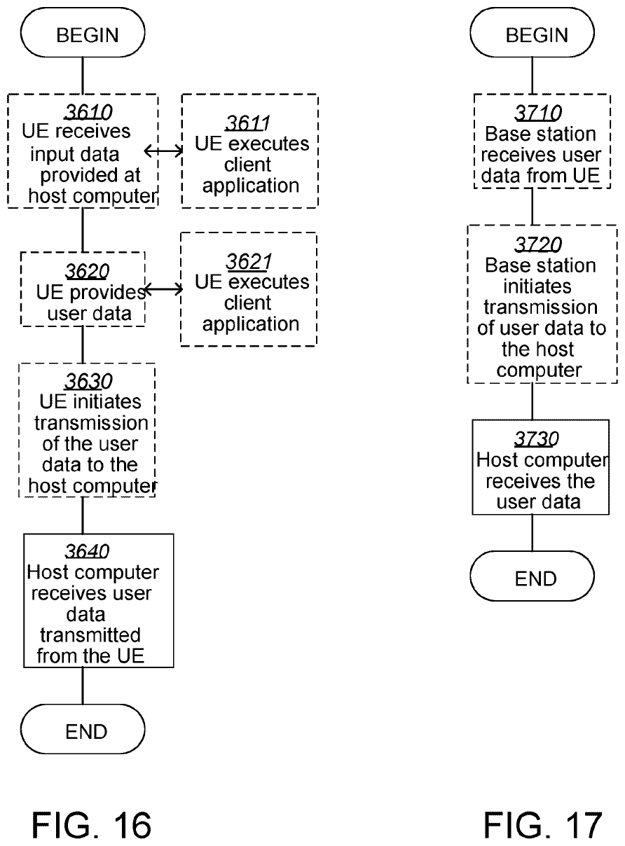

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 16 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a first Core Network, CN, node for assisting in selecting a serving Internet protocol Multimedia Subsystem, IMS, node instance to serve a User Equipment, UE, in a communications network, the method comprising:
sending to a second CN node a first subscription request to be informed about serving IMS node instances registered in the second CN node which serving IMS node instances are operating in an IMS network in the communications network;
receiving from the second CN node a list of serving IMS node instances and their respective profiles, according to the subscription request; and
when the UE registers in the IMS network, sending to a second IMS node, the list of serving IMS node instances and their respective profiles, to assist the second IMS node in selecting a specific serving IMS node instance to serve the UE based on the list of serving IMS node instances and their respective profiles.

2. The method according to claim 1, further comprising:
storing the list of serving IMS node instances and their respective profiles.

3. The method according to claim 2, further comprising:
receiving from a third CN node a second subscription request to be notified of any failure of any serving IMS node instance that has been allocated to the UE;
receiving from the second CN node a notification that a specific serving IMS node instance that has been allocated to the UE has failed;
identifying the specific serving IMS node instance, and its profile in the list of serving IMS node instances; and
sending to the third CN node, a notification that the specific serving IMS node instance that has been allocated to the UE has failed.

4-5. (canceled)

6. A method performed by a second Core Network, CN, node for assisting in selecting a serving Internet protocol Multimedia Subsystem, IMS, node instance to serve a User Equipment, UE, in a communications network, the method comprising:
receiving registration of a number of serving IMS node instances and their respective profile;
receiving from a first CN node a first subscription request to be informed about serving IMS node instances registered in the second CN node;
sending to the first CN node a list of the registered serving IMS node instances and their respective profiles, according to the subscription request.

7. The method according to claim 6, further comprising:
detecting a failure of a registered specific serving IMS node instance that has been allocated to a UE; and
sending to the first CN node a notification that a specific serving IMS node instance that has been allocated to the UE has failed.

8-9. (canceled)

10. A method performed by a first serving Internet protocol Multimedia Subsystem, IMS, node instance for assisting in selecting a specific serving Internet protocol Multimedia Subsystem, IMS, node instance to serve a User Equipment, UE, in a communications network, the method comprising:
sending to a second CN node a registration of the specific serving IMS node instance and its profile,
wherein the second CN node will inform a subscribing first CN node about the specific serving IMS node instance and its profile registered in the second CN node.

11. The method according to claim 27, wherein:
any failure of the specific serving IMS node instance that has been allocated to the UE will be detected by the second CN node based on the registration sent to the second CN node.

12-24. (canceled)

25. The method according to claim 2, wherein the notification enables the third CN node to send the notification to a Proxy IMS node to arrange for selecting another serving IMS node instance.

26. The method according to claim 6, wherein the sending to the first CN node enables the first CN node to assist a second IMS node in selecting a specific serving IMS node instance to serve the UE registered in the IMS network based on the list of serving IMS node instances and their respective profiles

27. The method according to claim 10, wherein the informing, by the second CN node, the subscribing first CN node enables the first CN node to assist a second IMS node in selecting a specific serving IMS node instance, to serve the UE registered in the IMS network, based on a list of serving IMS node instances and their respective profiles comprising the specific serving IMS node instance and its profile.
